(19) United States
(12) Patent Application Publication
(10) Pub. No.: US 2012/0119647 A1
(43) Pub. Date: May 17, 2012

(54) POTENTIAL CONTROL OF HEAT SINK IN SOLID-STATE LIGHT DEVICE

(75) Inventor: Chih-Peng Hsu, Sunnyvale, CA (US)

(73) Assignee: Ventiva, Inc., Santa Clara, CA (US)

(21) Appl. No.: 12/944,642

(22) Filed: Nov. 11, 2010

(51) Int. Cl. H01J 13/46; H01J 13/32; H01J 61/52

(52) U.S. Cl. 315/35; 313/46; 315/113

(57) ABSTRACT

Higher power light emitting diode (LED) modules are thermally managed by thermal coupling to a heat sink. An ion wind fan can be used to provide forced convection for the heat sink. In such a light device, in one embodiment the present invention includes electrically connecting the heat sink to the low voltage terminal of the LED driver, thereby controlling the potential of the heat sink.

### FIELD OF THE INVENTION

The embodiments of the present invention are related to a solid-state lighting device, and in particular to a solid-state lighting device containing an ion wind fan.

### BACKGROUND

It is well known that heat and the thermal management of heat is an issue for power light-emitting diodes (LEDs) used for illumination. Current LED light bulbs generally use a passive heat sink for thermal management. The body of the LED bulb is generally a metallic heat sink with fins to increase surface area for convection.

Heat sinks use conduction and convection to dissipate heat and thermally manage a heat-producing component. To increase the heat dissipation of a heat sink, a conventional rotary fan or blower fan has been used to move air across the surface of the heat sink, referred to generally as forced convection. Conventional fans would have many disadvantages when used in an LED light device, such as noise, weight, size, efficiency, and reliability caused by the failure of moving parts and bearings.

A solid-state fan using ionic wind to move air addresses many of the disadvantages of conventional fans. However, integrating an ion wind fan into a solid-state lighting device present numerous challenges.

### BRIEF DESCRIPTION OF THE DRAWINGS

FIG. 1 is a block diagram illustrating an ion wind fan implemented as part of thermal management of an electronic device;

FIG. 2A is a perspective view of an ion wind fan according to one embodiment of the present invention;

FIG. 2B is a widthwise cross-sectional view of the ion wind fan of FIG. 2A according to one embodiment of the present invention

FIG. 3 is an exploded view of an solid-state light bulb in which embodiments of the present invention can be implemented;

FIG. 4 is a perspective assembled view of the solid-state light bulb shown in FIG. 3;

FIG. 5 is a block diagram illustrating electrical connections in a solid-state light device according to one embodiment of the present invention; and

FIG. 6 is block diagram illustrating thermal management of an LED module according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode, getter electrode, or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

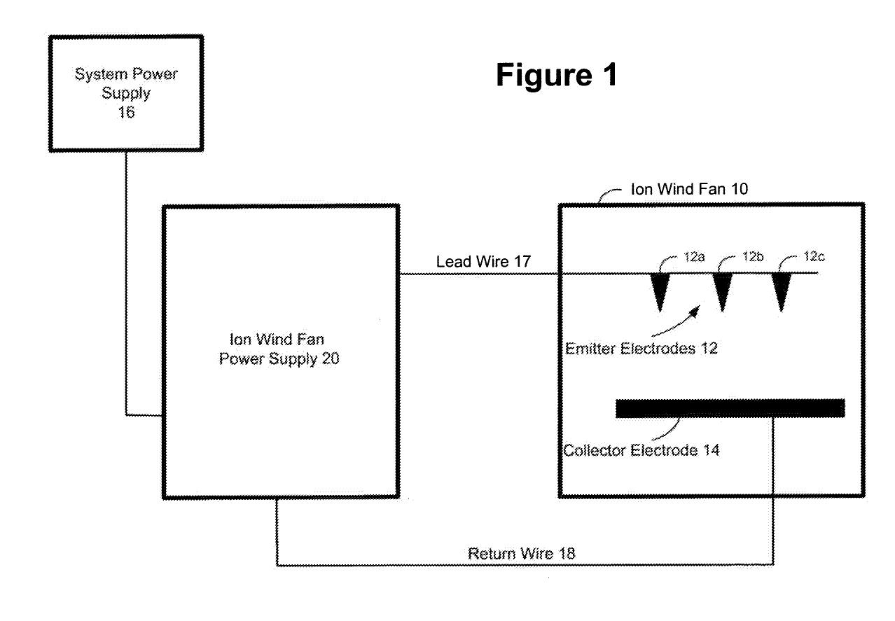

FIG. 1 illustrates an ion wind fan 10 used as part of a thermal management solution for an electronic device. As used in this Application, the descriptive terms “ion wind fan” and “ion wind” are used to refer to any electro-aerodynamic pump, electro-hydrodynamic (EHD) pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrode members (e.g., rods, washers) held at substantially the same potential. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

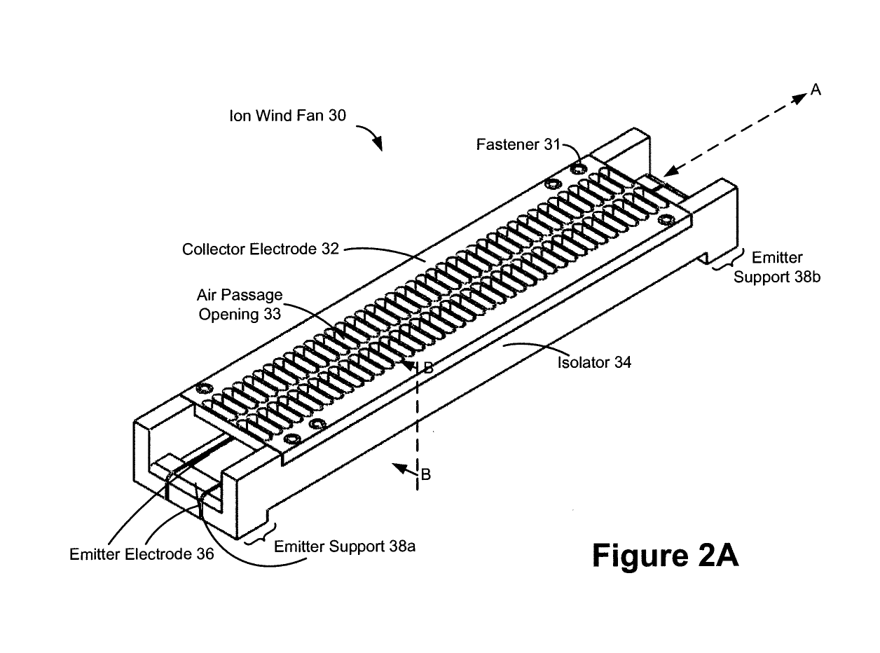

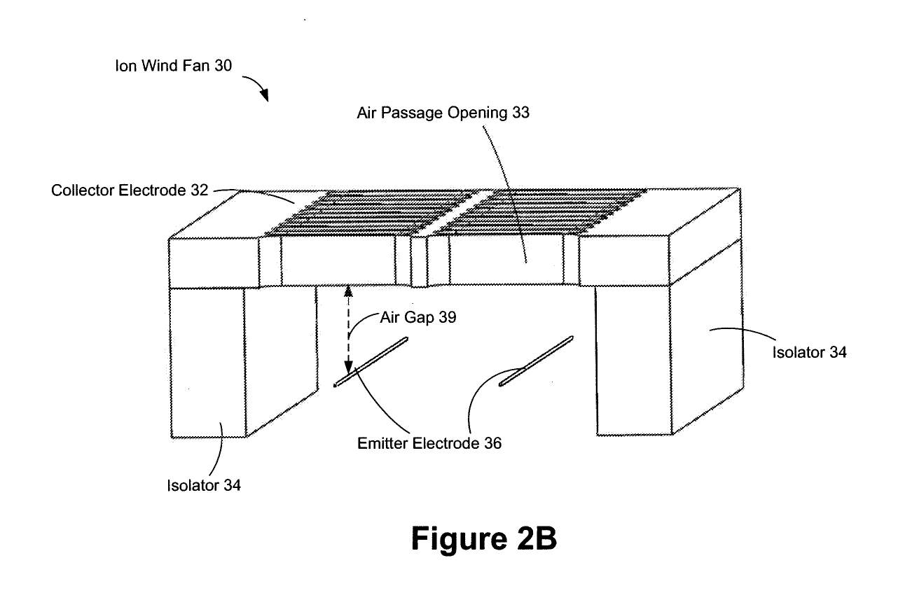

An example of such an ion wind fan is now described with reference to FIG. 2A and 2B. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic, ceramic, and the like. The “isolator” component is thusly named as it functions to electrically isolate the emitter electrodes 36 from the collector electrode 32, and to physically support these electrodes. As such the isolator also can establish the spatial relationship between the electrodes, sometimes referred to under the rubric of electrode geometry. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

In one embodiment, the emitter electrodes 36 are supported at the ends of the ion wind fan 30 by an emitter support 38 portion of the isolator 34. The emitter support 38a at the left end of the ion wind fan 30 is most visible in FIG. 2A. The emitter support 38a is a portion of the isolator that physically supports the emitter electrodes 36. In one embodiment, the emitter electrodes 36 are suspended (in tension) between the two emitter supports 38 at the two ends of the ion wind fan 30.

In the embodiment shown in FIG. 2A, the isolator 34 has two elongated members oriented along the longitudinal direction that support the collector electrode 32, and the two elongated members are held joined by two cross-members that support the emitter electrodes 36. In one embodiment, these cross-members are oriented perpendicular to the elongated members (and thus the longitudinal axis). In FIG. 2A, these cross-members make up the emitter supports 38.

Thus, while in one embodiment the emitter support 38a is a substantially rectangular solid portion of the isolator 34 that connects the two elongated side portions of the isolator 34, in other embodiments the emitter supports 38 can have many other shapes and orientations. For example, a part of the center portion of the emitter support 38a between the emitter electrodes 36 could be cut away without substantially affecting the function of the emitter support 38a.

The emitter support 38a is shown as extending to the end of the ion wind fan 30. However, in other embodiments, the emitter support 38a can end before the end of the ion wind fan 30. The emitter support 38a is also shown as having a curved section at its outside edge to smooth out the 90 degree bend in the wire emitter electrodes 36. This is an optional feature not related to the embodiments of the present invention described herein.

Indeed, the actual attachment of the emitter electrodes 36 to either the emitter support 38 or some other portion of the isolator 34 is not material to the embodiments of the present invention, and therefore will not be discussed in much detail for simplicity and ease of understanding. The emitter electrodes 36 are shown as extending downward from the left end of the ion wind fan 30 and they are connected to the power supply via some wire or bus, as is the collector electrode 32. The emitter supports 38 need not have any particular shape of contact with the emitter electrodes 36. The emitter supports 38 are the portions of the isolator 34 that define the physical spatial relationship between the emitter electrodes 34 and other components of the ion wind fan 30. How exactly the emitter supports 38 are in contact with the emitter electrodes 36 (grooves, stakes, friction, posts, welding, epoxy) are not germane to the embodiments of the present invention.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes established by the emitter supports 38 (which are not visible in FIG. 2B).

### LED Light Bulb

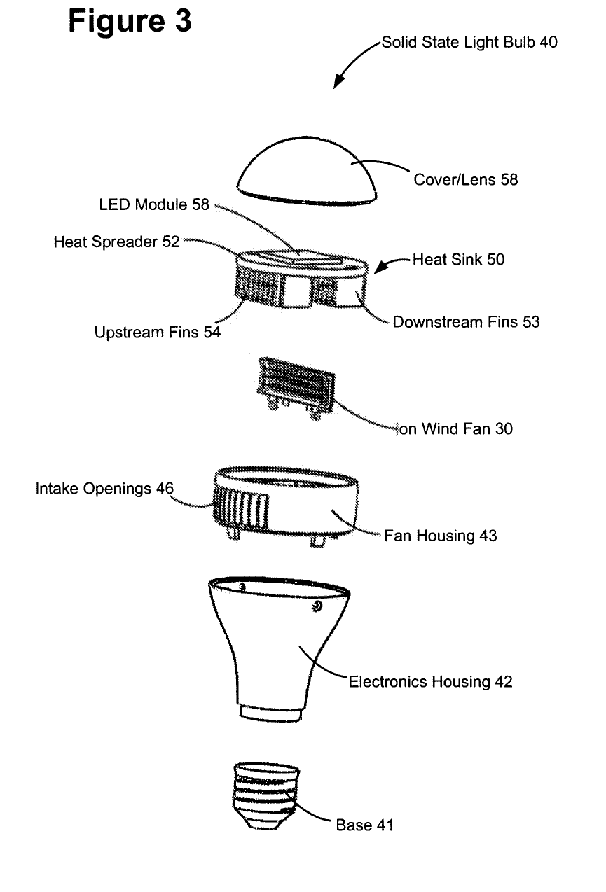

FIG. 3 shows some components of a solid-state (LED) light bulb 40 in an exploded view. Many components, such as drive electronics and electrical connections, have been omitted for simplicity, ease of understanding, and in order not to obscure the various embodiments of the invention.

In the embodiment shown, the light bulb 40 includes a screw-type base 41 to mate with a standard light socket to receive electricity from the mains power. In other embodiments various other electrical connectors and sockets could be used. The light bulb 40 includes a bulb housing, broken out into the electronics housing 42 and the fan housing 43 in FIG. 3. In one embodiment, the bulb housing is made of a dielectric material such as plastic, thermoplastic, ceramic, liquid crystal polymer, or any other known insulator. In other embodiments, the bulb housing can be constructed of a single unitary piece of injection-molded plastic, but it can be assembled from multiple pieces in other embodiments as shown. In other embodiment, other materials, such as metals, can be used.

The fan housing 43 includes a set of intake openings 46 and a set of exhaust openings that allow air to flow through the fan housing 43. The electronics housing 42 has a hollow cavity to house various electronics components, such as an LED power supply and driver, and the ion wind fan power supply. In one embodiment, this hollow cavity is then electrically from the fan housing 43.

In one embodiment, an ion wind fan 30 resides inside the fan housing 43, as shown in FIG. 3. The ion wind fan 30 is positioned to generate airflow from the intake openings 46 towards to exhaust openings (not shown), thereby causing a current of air through the fan housing 43. In one embodiment, the bulb 40 further includes a heat sink 50. As shown in FIG. 3, in one embodiment, the heat sink 50 has a flat, round shaped heat spreader 52 portion. However, in other embodiments, other shapes, such as square, octagonal, or other such shapes can be used for the heat spreader 52.

The heat spreader 52 portion of the heat sink 50 acts as the top surface of the fan housing 43, so that the upstream fins 54 and downstream fins 53 of the heat sink 50 reside in the fan housing 43, so that the airflow generated by the ion wind fan 30 impinges on the heat sink fins. The heat sink 50 can be manufactured as a single cast piece of metal, but other manufacturing techniques can also be used. In yet other embodiments, the heat spreader 52 and the fins 53-4 can be assembled from separate subcomponents (e.g. by welding on each fin).

In one embodiment, the LED module 58 providing illumination is mounted on the heat spreader 52. In FIG. 3 the surface on which the LED module 58 is mounted is opposite the surface from which the fins 53, 54 extend and which forms the top surface of the fan housing 43. In FIG. 3, an LED module 58 is shown, but it's understood that any solid-state light engine or light-producing element may be used.

Various commercially available LED modules 58 can be used, such as an ES-, RS-, or LS-Series LED Array available from BridgeLux Incorporated. However, any other LED engine, module, or array from any manufacturer can be used, in addition to other solid-state light engines currently available or not yet in existence. The bulb 40 also includes a cover/lens 58. The cover 58 is transparent or translucent, and may act as a lens or other optics.

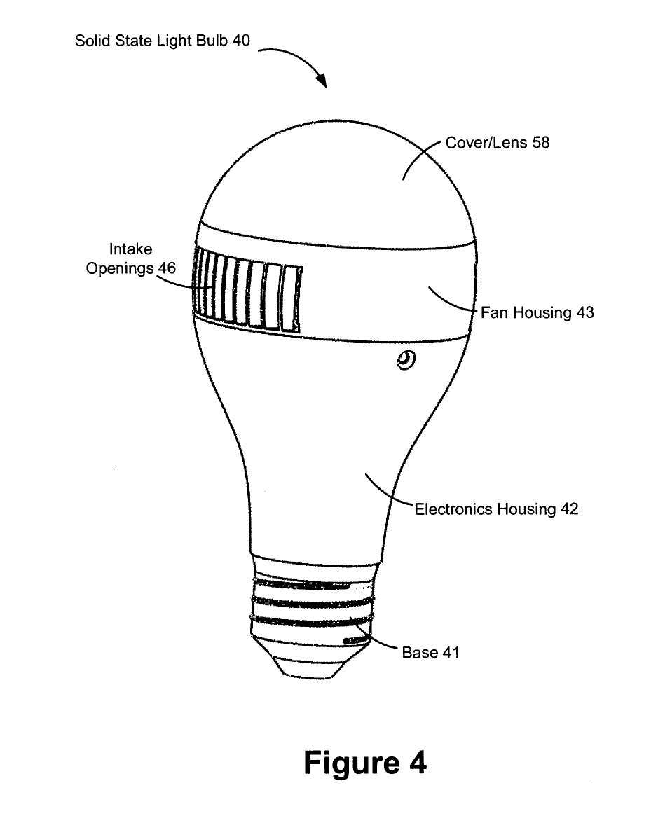

FIG. 4 shows the assembled view of the bulb 40 in perspective. The bulb 40 described with reference to FIGS. 3 and 4 is shown only for illustration. The present invention is not limited to any specific light bulb or lighting device shape, form, components, or implementation. All components described can be implemented in a variety of ways and shapes, some can be omitted, while others, such as the LED module 58 may be duplicated (i.e., multiple LED modules may be used). None of the specific designs shown in FIGS. 3 and 4 are meant to limit the invention in any way.

### Heat Sink Voltage Control

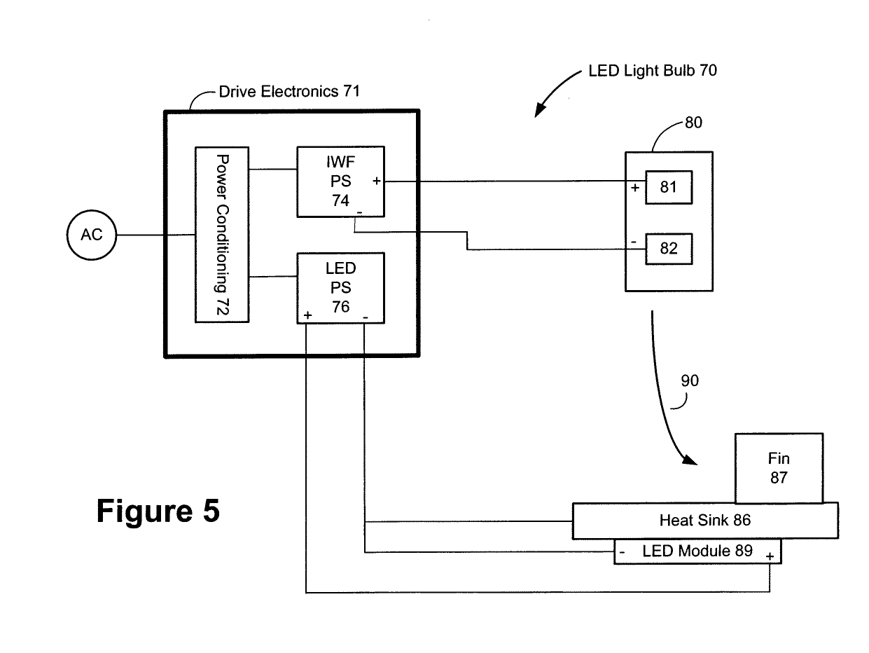

One embodiment of the present invention is now described with reference to FIG. 5. FIG. 5 is a block diagram illustrating several electrical connections between various devices, modules, and components, such as those shown in and described with reference to FIGS. 3-4. In FIG. 5, mains AC current is received at a light socket or other such connection of an LED bulb 70. The LED bulb 70 contains drive electronics 71 that include both an LED power supply 76 and an ion wind fan power supply 74.

The power conditioning electronics 72 can include various protection circuitry as well as a transformer or converter to alter the current to a format suited for the LED power supply 76 and an ion wind fan power supply 74. In one embodiment, the power conditioning circuit 72 includes a switched-mode power supply where the primary winding of the output transformer is part of the power conditioning 72 electronics and the IWF power supply 74 and the LED power supply 76 each have a secondary winding to the output transformer. However, the drive electronics 71 can be implemented is a variety of ways, and the specific implementations are not relevant to the various embodiments of the present invention.

Also shown in FIG. 5 is an LED module 89 mounted to a heat sink 86 having one or more heat sink fins 87. The light bulb 70 also includes an ion wind fan 80 having one or more emitter electrodes 81 and one or more collector electrodes 82. The ion wind fan is arranged to provide an airflow 90 that impinges on the heat sink 86 to provide forced convection. These components can be implemented and designed similarly to those embodiments described above or in numerous other ways, and are thus represented only as abstract blocks.

In one embodiment, the LED module 89 uses direct current (DC) to power its LEDs. For example, a BridgeLux Part Number BXRA-C2002 ES-Serieas LED Array operates at around 16 volts (V) DC. Most currently available LED modules operate in the range of 7-30V DC. The LED power supply 76 is designed to provide current at the voltage required by the LED module 89.

The LED power supply 76 has a positive (high) terminal and a negative (low) terminal, denoted by a + and a − respectively. The voltage potential between the high voltage terminal 76(+) and the low voltage terminal 76(−) is the voltage at with the current is provided to the LED module 89. The LED module 89 also has a high voltage terminal 89(+) and a low voltage terminal 89(−). As is understood by those skilled in the art, the LED module 89 is powered by the LED power supply 76 by electrically coupling the high voltage terminals together—76(+) and 89(+)—and the respective low voltage terminals together—76(−) and 89(−)—as shown in FIG. 5.

Similarly, in one embodiment, the emitter electrodes 81 of the ion wind fan 80 are connected to the high voltage terminal 74(+) of the ion wind fan power supply 74 and the collector electrode 82 is connected to the low voltage terminal 74(−). In other embodiments, the ion wind fan 80 may use negative corona or AC coronal implementations. In one embodiment, the voltage generated by the ion wind power supply is thousands of volts, and thus much exceeds the voltages produced by a typical LED power supply 76.

In one embodiment, the heat sink 86 and the heat sink fins 87 are made of electrically conductive material, such as metals like aluminum or copper. As explained above, the ion wind fan 80 operates by creating an electrostatic field and moving charged particles (ions). Since the ion wind fan 80 is physically positioned to provide forced convection for the heat sink 86, it is generally in relatively close proximity to the heat sink 89. In FIG. 3, for example, the bulb 40 is the approximate size of an A-19 light bulb, and the ion wind fan 30 is approximately 5-10 mm away from the heat sink 50.

Because of this proximity, the heat sink can become charged or conduct some current due to being in the electrostatic field or by impacts from moving charged particles. If the differential voltage across the heat sink 86 and the LED module 89 exceeds a certain threshold, arcing or other undesirable current flow can occur between the heat sink 86 and the LED module 89. In one embodiment, these issued caused by having an ion wind fan 80 in close proximity to a metallic heat sink 86 used to thermally manage an LED module 89 are addressed by electrically coupling the heat sink 86 to the low voltage terminal of the LED power supply 76(−), as shown in FIG. 5.

Usually, a light socket is not grounded, and has only two electrical connections. Thus, the absolute potential of the low voltage terminal 76(−) is not always known, and is implementation specific. It usually will not be at the same potential as the “neutral” wire coming into the light socket, but in some cases it may be. However, the electric potential of the heat sink 86 is controlled by connecting it to the low voltage terminal 76(−) of the LED power supply 76, and thus not allowing it to float to whatever potential its environment would allow. In such an embodiment, the heat sink 86 cannot be grounded, but should be voltage controlled to be at the same potential as the LED module 89.

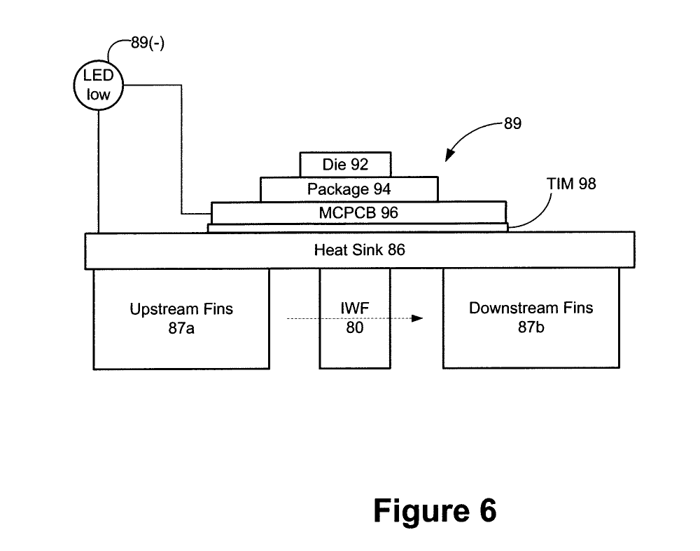

FIG. 6 is another block diagram of a specific implementation of the present invention. In FIG. 6, the voltage of the low voltage terminal 89(−) is represented by a circle labeled “LED low.” The LED module 89 includes a die 92 layer including that LED dies, a package 94 layer including the packaged dies 92, and a metal core printed circuit board (MCPCB) 96 on which the package 94 is mounted. The high 89(+) and low 89(−) voltage LED terminals are located on the MCPCB 96. For high-power LEDs, the metal core of the MCPCB is used to remove the heat generated at the LED dies 92. The metal core of the MCPCB, in one embodiment, is electrically connected to the low terminal 89(−) of the LED module 89, thus having the potential of the metal core be the same as the low voltage terminal 76(−) of the LED power supply 76.

In one embodiment, the MCPCB is mounted on the heat sink 86 using a thermal interface material (TIM) 98 that acts both as an adhesive and as an efficient conductor of heat. In other embodiments, the MCPCB 86 can be directly coupled to the heat sink 86. In yet other embodiments in which no MCPCB is used, the LED package 94 can be directly mounted on the heat sink 86, or use a plurality of heat slugs in thermal contact with the heat sink 86.

In the embodiment shown, the heat sink 86 has two sets of fins 87, one upstream 87a and one downstream 87b of the ion wind fan 80, much like as shown in FIG. 3. The ion wind fan 80 creates airflow as indicated by the dotted arrow. As shown again in FIG. 6, the heat sink 86 is connected to the LED low potential 89(−), thus holding the heat sink 86 and the heat sink fins 87 at the same potential as the low sides of the LED power supply 76(−) and the low terminal on the MCPCB 96. In one embodiment, the TIM 98 is also electrically conductive, thus, the TIM will also be at the same potential as the heat sink 86—LED low 89(−).

In the descriptions above, various functional modules are given descriptive names, such as “ion wind fan power supply,” and “LED power supply.” The functionality of these modules can be implemented in software, firmware, hardware, or a combination of the above. None of the specific modules or terms—including “power supply” or “ion wind fan”—imply or describe a physical enclosure or separation of the module or component from other system components. Also, terms such as “lamp,” “light device,” “light bulb,” and the like are used interchangeably in this application, without limitation to any specific shape.

Furthermore, descriptive names such as “emitter electrode,” “collector electrode,” and “isolator,” are merely descriptive and can be implemented in a variety of ways. For example, the “collector electrode,” can be implemented as one piece of metallic structure (as shown in the FIG. 2, for example), but it can also be made of multiple members spaced apart, and connected by wires or other electrical connections to the same voltage potential, such as ground.

Similarly, the isolator can be the substantially frame-like component shown in FIG. 2, but it can have various shapes. The electrodes and the isolator are not limited to any particular material; however, the isolator will generally be made of a dielectric material, such as plastic, ceramic, and other known dielectrics. Thus in one embodiment, any of the collector electrodes discussed herein can be substituted for the collector electrode 32 of FIG. 2A to create an ion wind fan according to an embodiment of the present invention. In other embodiments, other isolator designs can be used, as long as it establishes substantially the same spatial relationships between the electrodes. Similarly, the present invention applies to any solid-state lighting device, and is not limited to the specific light bulb shown in FIGS. 3 and 4.

Furthermore, various directional and orientational terms such as “front” and “back” and “rear,” “left” and “right,” “top” and “bottom,” and the like are used herein only for convenience. No fixed or absolute directional or orientational limitations are intended by the use of these words. For example, an LED light bulb may be installed facing down or facing up. Alternatively, various components may be oriented differently inside of the LED bulb without altering the fundamental nature of the scope and spirit of this invention.

1. An LED lamp comprising:
an LED array mounted on a board having a metal core; and
a heat sink, wherein the board is mounted to the heat sink;
wherein the metal core of the board and the heat sink are held at the same electric potential.

2. The LED lamp of claim 1, further comprising an LED power supply having a high side and a low side, the LED power supply configured to provide power to the LED array, wherein the metal core of the board and the heat sink are held at the same electric potential as the low side of the LED power supply.

3. The LED lamp of claim 2, wherein the metal core of the board and the heat sink are electrically coupled to the low side of the LED power supply.

4. The LED lamp of claim 2, wherein the heat sink is coupled to the low side of the LED power supply by a wire.

5. The LED lamp of claim 1, wherein the board comprises a metal core printed circuit board (MCPCB).

6. The LED lamp of claim 1, further comprising an ion wind fan configured to provide forced convection for the heat sink by generating ion wind.

7. An LED light bulb comprising:
an LED module comprising a plurality of LEDs, the LED module comprising a board having a high voltage contact and a low voltage contact;
an LED power supply having a high voltage terminal and a low voltage terminal, wherein the high voltage terminal of the LED power supply is electrically coupled to the high voltage contact of the LED module and the low voltage terminal of the LED power supply is electrically coupled to the low voltage contact of the LED module; and
a heat sink electrically coupled to the low voltage terminal of the LED power supply, wherein the LED module is thermally coupled to the heat sink.

8. The LED light bulb of claim 7, wherein the LED module comprises an LED package mounted to a printed circuit board (PCB) and wherein the high voltage contact and the low voltage contact reside on the PCB.

9. The LED light bulb of claim 8, wherein the PCB is a metal core PCB (MCPCB).

10. The LED light bulb of claim 8, wherein the PCB is attached to the heat sink via a thermal interface material.

11. The LED light bulb of claim 7, further comprising an ion wind fan to generate an airflow to provide forced convection for the heat sink.

12. The LED light bulb of claim 11, wherein the ion wind fan comprises at least one emitter electrode and at least one collector electrode.

13. The LED light bulb of claim 12, further comprising an ion wind fan power supply having a high voltage terminal and a low voltage terminal, wherein the emitter electrode is electronically coupled to the high voltage terminal of the ion wind fan power supply and the collector electrode is electronically coupled to the low voltage terminal of the ion wind fan power supply.

14. The LED light bulb of claim 11, wherein the heat sink comprises a heat spreader having an attachment surface and a fin surface opposite the attachment surface, wherein the heat sink further comprises a plurality of fins protruding from the fin surface, the plurality of fins defining a plurality of channels.

15. The LED light bulb of claim 14, wherein the LED module is thermally coupled to the attachment surface of the heat spreader and the ion wind fan is configured so that the airflow generated passes through the plurality of channels defined by the plurality of fins.

16. A solid-state lighting device comprising:
a solid-state light engine comprising a plurality of solid-state light devices, the light engine comprising a board having a high voltage contact and a low voltage contact;
an first power supply having a high voltage terminal and a low voltage terminal, wherein the high voltage terminal of the first power supply is electrically coupled to the high voltage contact of the solid-state light engine and the low voltage terminal of the first power supply is electrically coupled to the low voltage contact of the solid-state light engine; and
a heat sink electrically coupled to the low voltage terminal of the first power supply, wherein the solid-state light engine is thermally coupled to the heat sink.

17. The solid-state lighting device of claim 16, further comprising a second power supply and an ion wind fan electrically coupled to the second power supply, wherein the ion wind fan is configured to provide forced convection for the heat sink.
